(19) United States
(12) Patent Application Publication
(10) Pub. No.: US 2005/0243988 A1
(43) Pub. Date: Nov. 3, 2005

(54) Telephone switching system and method for alerting for priority calls

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: LUCENT TECHNOLOGIES INC.;DOCKET ADMINISTRATOR, 101 CRAWFORDS CORNER ROAD - ROOM 3J-219, HOLMDEL, NJ, 07733, US

(21) Appl. No.: 10/837,080

(22) Filed: Apr. 30, 2004

(51) Int. Cl. H04M 3/42; H04M 1/66; H04M 1/00

(52) U.S. Cl. 379/207.13; 379/373.02

(57) ABSTRACT

A method and apparatus are provided for providing a priority alert at a communication device for certain designated callers on a per call basis. Either a priority call is requested at call origination (302, 304, 306) or after a normal call is not answered (406). Where a priority call request is made at call origination, the caller must supply a valid identification designation that is verified before a priority alert is sent (312). A telephone switch (106, 110) that terminates services to the communication device determines whether the priority call is permitted and initiates the priority alerting at the communication device (316). Where a normal (non-priority) call is not answered (406), a terminating switch or voicemail system coupled to the terminating switch prompts the caller to make a priority request and enter a valid priority identification designation (410, 512). Where a priority call is requested (412, 514), the terminating switch or voicemail system then provides a priority alert to a communication device (418, 520), if the priority identification designation is valid and authorized. The priority alert is, alternatively, distinctive ringing, a visual display, a distinctive call waiting alert, a data message, or the like.

### FIELD OF THE INVENTION

The present invention relates generally to telephone switching system features, and in particular, to a method and apparatus for alerting a communication device that is coupled to a telephone switching system to a priority call.

### BACKGROUND OF THE INVENTION

Subscribers to communication services are often reluctant to accept certain calls received over their communication device. Caller identification helps alleviate such circumstances by providing some identification of the caller or the calling communication device. Using distinctive ringing tones for certain calling numbers provides an audible method for distinguishing callers or calling numbers. Yet, there are still times that caller identification alone is not sufficient for a subscriber to determine whether an incoming call should be answered. For example, a routine incoming call from a family member might not be desirable in the midst of an important business meeting. On the other hand, an emergency incoming call from a family member may require immediate attention, regardless of the circumstances. Unfortunately, caller identification and distinctive ringing for certain callers do not help determine whether a particular call from a caller is of a high enough priority that it requires immediate attention.

Therefore, a need exists for a method and apparatus for alerting a user of a communication device to a high priority call from a person authorized to make such calls.

### SUMMARY OF THE INVENTION

The need is met and an advance in the art is made by the present invention, which allows, on a per call basis, for certain callers to make priority calls to a communication device, if those callers have the appropriate authorization from a user of the communication device.

According to the invention, a communication device is alerted to a priority call. The terminating switch that couples the communication device to a telephone network receives an incoming call. The switch determines whether the incoming call includes a request for a priority call. In one aspect, a priority call includes a priority call request and a priority identification supplied by an originator of the call at the time of call origination. In another aspect, a priority call is determined when the originator enters a priority call request and a priority identification after prompting, if a first call is not answered. If the call is a priority call and the priority identification entered by the call originator matches a stored valid priority identification, a priority alert is sent to the communication device. The priority alert is alternatively a distinctive ring, a visual alert, a distinctive call waiting alert or a data message, such as a short message service (SMS) message.

### BRIEF DESCRIPTION OF THE DRAWINGS

FIG. 1 is a block diagram of a communications system that includes telephone switches for alerting communication devices of priority calls in accordance with the present invention.

FIG. 2 is a flow chart illustrating a method for registering a priority identification designation for use in accordance with the present invention.

FIG. 3 is a flow chart illustrating a method for alerting a communication device of a priority call in accordance with the present invention.

FIG. 4 is a flow chart illustrating an alternative method for alerting a communication device of a priority call in accordance with the present invention.

FIG. 5 is a flow chart illustrating yet another alternative method for alerting a communication device of a priority call in accordance with the present invention.

### DESCRIPTION OF THE PREFERRED EMBODIMENTS

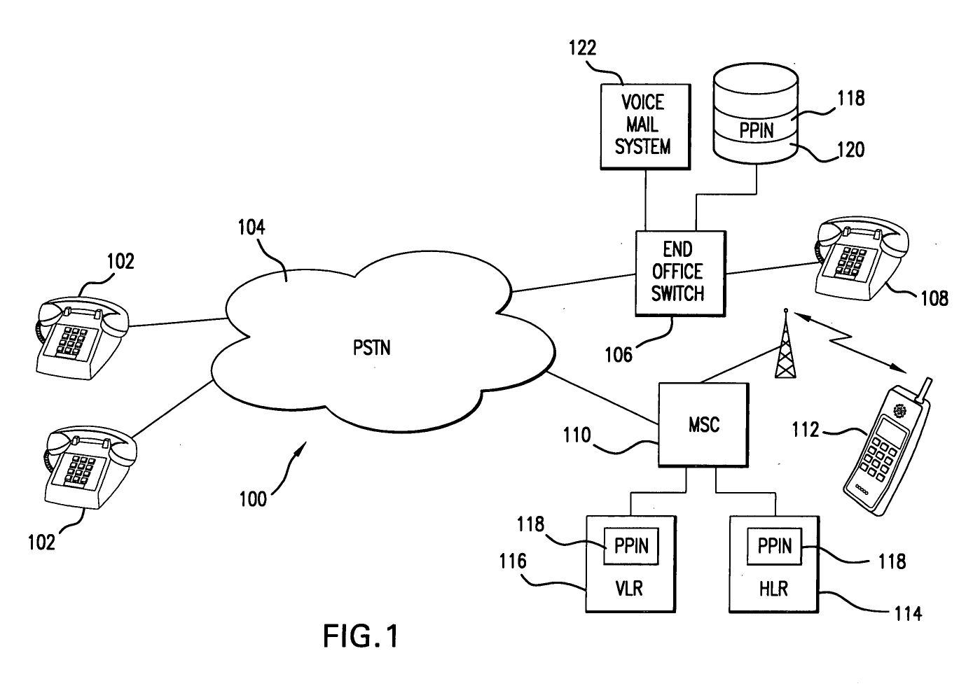

FIG. 1 is a block diagram of a communications system 100 with telephone switching systems in accordance with the present invention. Communications system 100 includes a plurality of telephones 102 coupled to the public switched telephone network 104 (which may include elements of the public land mobile network) in a conventional manner. Communications system 100 also includes an end office switch 106 that is coupled to the public switched telephone network 104 in a conventional manner. End office switch 106 provides telephone 108 a wired interface to the public switched telephone network 104. Similarly, communications system 100 includes a mobile switching center (MSC) 110 that is coupled to the public switched telephone network 104 in a conventional manner. MSC 110 provides wireless communication device 112 a wireless interface to the public switched telephone network 104. As will be appreciated by those of skill in the art, end office switch 106 and MSC 110 are terminating switches, in that they provide the termination of phone calls to telephone 108, wireless communication device 112 and the like. Preferably, end office switch 106 and MSC 110 include one or more processors that are programmed to implement switching features and the methods of the present invention.

MSC 110 is coupled to a home location register (HLR) 114 and a visitor location register 116 in a conventional manner. HLR 114 stores, among other things, subscriber records for those subscribers associated with a service provider controlling MSC 110. VLR 116 stores, among other things, subscriber records for wireless subscribers that are presently communicating with MSC 110, but who are normally associated with another mobile switching center or service provider. In accordance with the present invention, HLR 114 and VLR 116 store a priority personal identification number (PPIN) 118 that is associated with a subscriber and used to validate whether a priority call may be made.

End office switch 106 is coupled to a database 120 of subscriber records in any conventional manner, including connection through the public switched telephone network 104. In accordance with the present invention, database 120 stores a priority personal identification number (PPIN) 118 that is associated with a subscriber and used to validate whether a priority call may be may made to that subscriber. A voicemail system 122 is also coupled to end office switch 106 in a conventional manner. Voicemail system 122 preferably includes one or more processors that are programmed to implement desired functionality, including the novel methods of the present invention. While voicemail system 122 is shown in FIG. 1 coupled to end office switch 106, an analogous voicemail system may be coupled to MSC 110 and operated in accordance with the present invention.

As discussed further below, in accordance with the present invention, communication devices, such as wireless communication device 112 and telephone 108, are enabled to receive priority calls from call originators that designate the calls as priority calls and enter a valid PPIN.

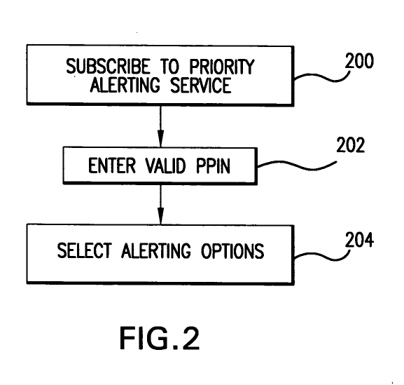

FIG. 2 is a block diagram illustrating a method for registering a priority identification designation or PPIN in accordance with the present invention. In order to receive priority calls, a subscriber must elect to use this feature and provide a priority identification designation or PPIN that others can use to make valid priority calls. First, the subscriber must subscribe to the priority alerting service (200). Subscription to the priority alerting service may be accomplished in any known manner, including by oral communications with a service provider, Internet subscription to subscriber features, subscription through an interface on a communication device or the like. Preferably, during the subscription process, the subscriber enters one or more valid priority identification designations or PPINs (202). In one preferred embodiment, only one PPIN is used per subscriber and all call originators authorized to make priority calls use that PPIN. In other embodiments, a PPIN may be associated with individual call originators or groups of call originators as desired, thereby providing multiple PPINs for different purposes.

In accordance with the invention, a user of a communication device is alerted to a priority call in some distinctive manner. Preferably, the manner for alerting a user to a priority call is different from a manner used to alert the user to a normal or non-priority call. Alternatives for providing an alert for a priority call include distinctive ringing tones, a distinctive visual display, a distinctive call waiting audible response or display, a data message, or a combination of these. Most preferably, a subscriber selects the desired option for being alerted to a priority call during the process of subscribing to the alerting service (204).

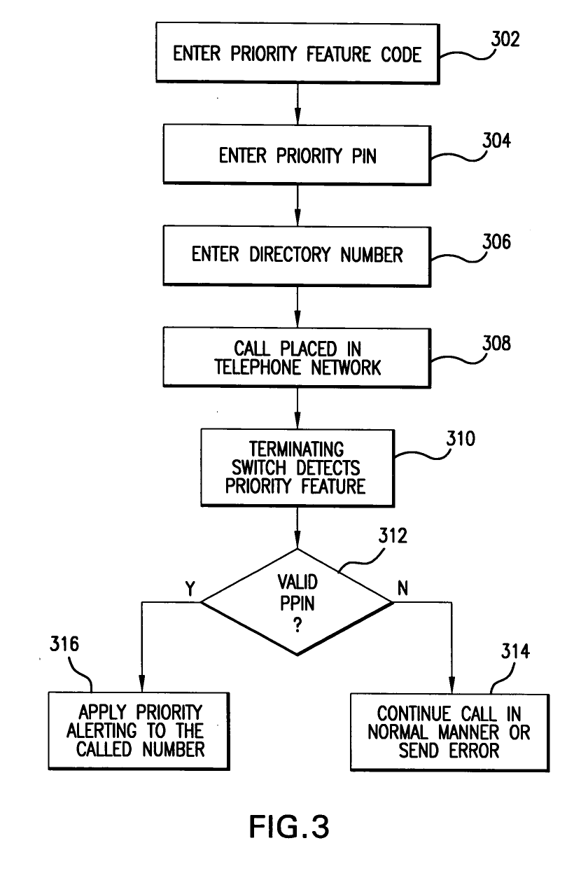

FIG. 3 is a flow chart illustrating one embodiment of a method for alerting a user of a communication device to a priority call in accordance with the invention. The method illustrated by FIG. 3 is characterized in that the call originator selects a priority call during call origination, and this priority call request is transmitted through the entire public switched telephone network 104 and processed by a terminating switch.

First, during call origination, the initiator of the phone call enters a priority feature code (302). The priority feature code is a new designation that alerts the communications system that a priority call is desired. Preferably, the priority feature code is entered as DTMF tones or other input signaling from a communication device. For example, the priority feature code might be “*49.” Of course, any other suitable method of alerting the communications system that a priority call is desired may be used.

After the priority feature code is entered, but continuing with the call origination process, a priority personal identification (PPIN) or priority identification designation is entered (304). Preferably, the PPIN is followed by the directory number during the call origination process (306). Then the call is placed in the telephone network (308). Preferably, the priority feature code and the PPIN are transmitted through communications system 100 by the inter-office signaling system in a conventional manner. Alternatively, any other method for transmitting this data to a terminating switch is used.

The terminating switch receives the priority feature code and the PPIN and determines that a priority call to the subscriber identified by the directory number is desired (310). If the identified subscriber has allowed the priority alerting feature, then the terminating switch determines whether the PPIN transmitted with the call is valid (312). Of course, if the priority feature is not enabled for the desired subscriber, then an error message or tone may be delivered back to the call originator and the call may be connected to the communication device in the normal manner. Where the priority feature is enabled, preferably, the PPIN transmitted with a call is compared to a stored PPIN previously determined by the subscriber for validation. If the PPIN is not valid, then the call can be continued as a normal (non-priority) call and/or an error message or tone may be returned to the call originator (314). On the other hand, if a valid PPIN was entered at call origination, then priority alerting is applied to the called directory number (316). In particular, the communication device associated with the called number is alerted to the priority call in a default manner or manner selected by the subscriber (204). For example, if the communication device is idle, that is, not in use, then a distinctive alert at the communication device may signify to a user that a priority call is on the line. The distinctive alert is alternatively a different ringing tone, a different rhythm of rings/tones, or some other distinctive audible pattern. As will be appreciated by those of skill in the art, the characteristics comprising the priority alert is only limited by the communication device and the switch terminating the call. If the communication device is not idle, that is, in use, then a distinctive call waiting tone may be applied to an ongoing call. Preferably, the distinctive call waiting tone includes an identifier that may be correlated to the PPIN used to make the call.

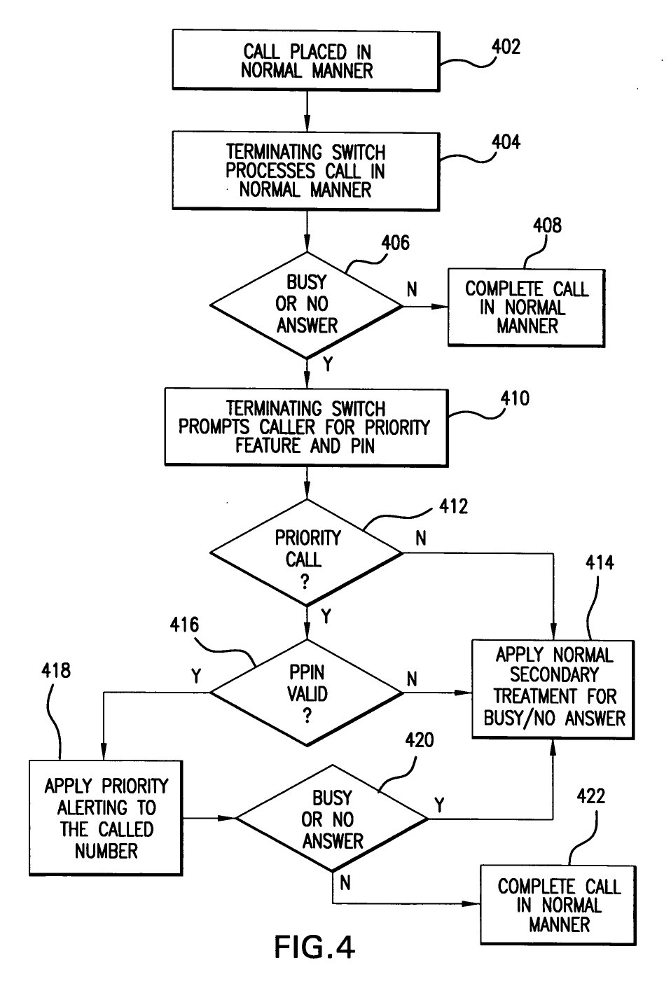

FIG. 4 is a flow chart illustrating another embodiment of a method for alerting a user of a communication device to a priority call in accordance with the present invention. The method illustrated by FIG. 4 is characterized in that the terminating switch completely handles the priority call without the need to send a priority call request and priority identification designation through the network. Therefore, in contrast to the method shown in FIG. 3, this method does not require the proliferation of changes to accommodate such a method in the entire telephone network.

First, during call origination, the initiator of the phone call originates the phone call in the normal manner (402). That is, if all that is normally required to place a call is the directory number, then the directory number is entered. Notably, this is in contrast to the entry of a priority call request and a priority identification designation, as specified in the method of FIG. 3 (302, 304).

After the call is initiated, the call travels through the network in the normal manner and is processed at the terminating switch in the normal manner (404). In other words, a normal (non-priority) call is made to the communication device. If that call is answered (406), then there is no need for a priority call and the call is handled in the normal manner (408). Notably, answering the call includes answering an idle phone or answering a call while the device is in use due to a call waiting tone or alert.

If on the other hand, the call rings busy or there is no answer (406), then a priority call may be appropriate. According to this embodiment, in order to ascertain whether a priority call is desired, the terminating switch provides an audible prompt to the call originator for a priority call feature and priority identification designation, if desired (410). The audible prompt may be in the form of a question with selectable responses. Or the audible prompt may simply be in the nature of a tone. If no priority call is desired or no priority identification designation is entered (412), then normal secondary treatment is applied to the call (414). Normal secondary treatment includes, for example, transfer to a voicemail system or to a standard message. During the time that the originator is prompted, the normal call is preferably suspended. That is, ringing or further attempts to reach the called number are not made.

If a priority call is requested and a priority identification designation is entered (412), then the priority identification designation is checked for validity (416). That is, a determination is made as to whether the priority identification designation entered by the call originator matches a priority identification designation stored and associated with the called subscriber. If the priority identification designation is not valid (416), then normal secondary treatment is provided for the call (414). And an error message may be sent to the call originator, if desired.

If a valid priority identification designation is entered (416), then priority alerting is applied to the called number (418). That is, the communication device associated with the called number is alerted to the priority call in a default manner or any manner selected by the subscriber (204). Some alternatives for providing the priority alert are discussed above with respect to step 316. If the priority call is answered (420), then the call is completed in the normal manner (422). If the priority call is not answered, then normal secondary treatment is applied (414).

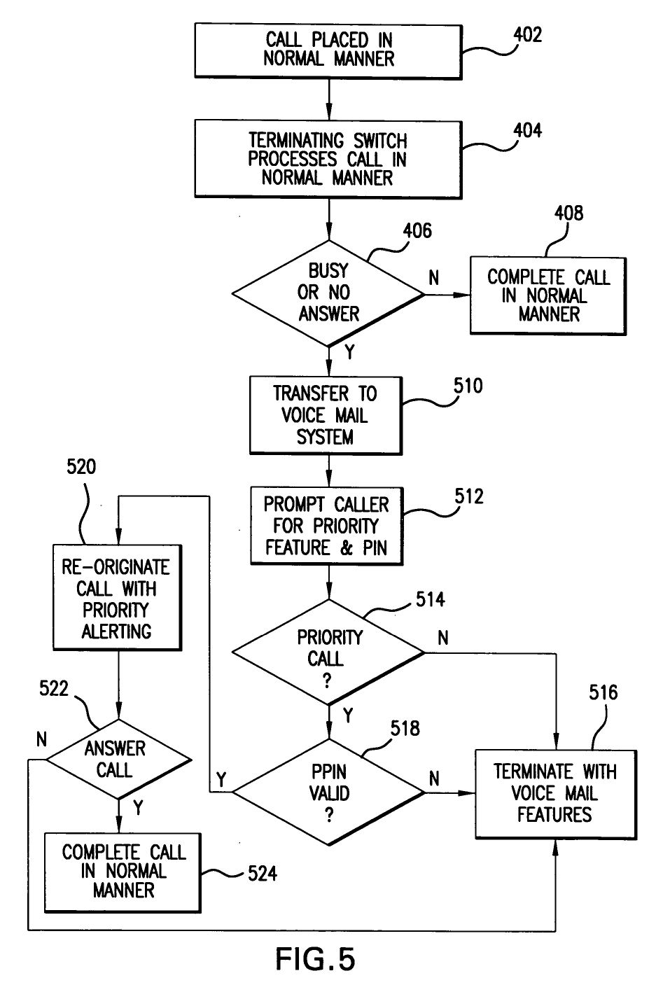

FIG. 5 is a flow chart illustrating yet another embodiment of a method for alerting a user of a communication device to a priority call in accordance with the present invention. The method illustrated in FIG. 5 is characterized in that a voicemail system coupled to the terminating switch is used to handled the priority call. As with the method illustrated by FIG. 4, there is no need to send a priority call request and priority identification designation through the telephone network at call origination. The method illustrated by FIG. 5 has the advantage of requiring no changes in the telephone network and no or minimal changes in the terminating switch.

As illustrated by the use of common reference numerals 402, 404, 406, and 408, the first few steps of the method illustrated in FIG. 5 are identical to the first few steps of the method illustrated in FIG. 4. In particular, the call is originated in the same manner and delivered to a communication device (402, 404, 406). If the call is answered, then the call is completed in the normal manner (408). However, if a communication device is busy or there is no answer (406), then the call is transferred to a voicemail system (510). The voicemail systems then prompts the caller to make a priority call request and a priority identification designation (PPIN) (512). If a priority request is not entered (514), then the call is terminated with the normal voicemail features (516). If a priority call is requested (514), then the priority identification designation entered is checked for validity (518). If a valid priority identification designation is not entered (518), then the call is terminated with the normal voicemail features (516). If a valid priority identification designation is entered (518) then the voicemail system preferably places a call with priority alerting to the communication device (520). The priority alert to the communication device is made in any manner specified herein. In addition, the priority alerting may be accomplished by the voicemail system sending a particular caller identification with the priority call in the communication device recognizing that caller ID in applying any special alert, for example, distinctive ringing for the caller ID associated with the voicemail system. In addition, the voicemail system may provide the priority alerting by sending a data message, such as a SMS message or the like, which may precede the priority call.

If the priority call (520) is answered (522), then the call is completed in the normal manner with the call originator and the communication device (524). If the priority call (520) is not answered (522), then the call is terminated with voicemail features provided to the call originator (516).

The present invention advantageously provides a method and apparatus for providing priority calls to a communication device. The priority call is alternatively accomplished at call origination or after a normal call is not answered. A priority identification designation limits the callers that can make priority calls. The terminating switch or a voicemail system coupled to a terminating switch provide minimally evasive methods for implementing the new method and apparatus in an existing system.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method for alerting a communication device associated with a user to a priority call, the method comprising the steps of:
receiving a call request in a terminating switch coupled to the communication device, the call request including a priority call request and a priority identification designation;
determining that the priority call request is a request to alert the user of the priority call;
determining whether the priority identification designation is a valid priority identification designation; and
if the priority identification designation is a valid priority identification designation, then providing a priority alert to the communication device associated with the user.

2. The method of claim 1 wherein the priority alert is distinguished from a non-priority alert and comprises at least one of: a predetermined ring tone, a visual display, a predetermined call waiting treatment, and a data message.

3. The method of claim 1 wherein the step of determining whether the priority identification is a valid priority identification further comprises the step of:
determining whether the priority identification matches a valid priority identification designation stored in a database accessible by the terminating switch.

4. The method of claim 3 wherein the valid priority identification designation is stored in one of: a home location register, a visitor location register, and a subscriber record.

5. The method of claim 1 wherein the valid priority identification designation is predetermined by the user.

6. A method for alerting a communication device associated with a user to a priority call, the method comprising the steps of:
A) receiving a call request in a terminating switch coupled to the communication device;
B) the terminating switch alerting the communication device of the call request;
C) the terminating switch determining the call is not being answered by the user of the communication device;
D) after determining the call is not being answered, prompting an originator of the call to enter a priority call request and a priority identification designation;
E) after receiving a priority call request and a priority identification designation, determining whether the priority identification designation matches a valid priority identification designation; and
F) if the priority identification designation matches a valid priority identification designation, then alerting the communication device to new call by providing a priority alert to the communication device associated with the user.

7. The method of claim 6 wherein steps D through E are performed by one of: the terminating switch and a voice mail system coupled to the terminating switch.

8. The method of claim 7 wherein steps D through E are performed by the voice mail system and the priority alert is a data message indicating that the communication device will receive a priority call.

9. The method of claim 8 wherein the data message is a short message service message.

10. The method of claim 6 wherein the priority alert is distinguished from a non-priority alert and comprises one of: a predetermined ring tone, a visual display, a predetermined call waiting treatment, and a data message.

11. The method of claim 6 wherein the step of determining whether the priority identification designation matches a valid priority identification designation further comprises the step of:
determining whether the priority identification designation matches a valid priority identification designation stored in a database accessible by the terminating switch.

12. The method of claim 11 wherein the valid priority identification designation is stored in one of: a home location register, a visitor location register, and a subscriber record.

13. The method of claim 6 wherein the valid priority identification designation is predetermined by the user.

14. An apparatus for altering a user to a priority call, the apparatus comprising:
a switching system coupled to a telephone network;
a communication device coupled to the switching system;
wherein the switching systems is coupled to a processor that:
determines whether an incoming call for the communication device is a priority call;
and if the incoming call is a priority call, determines whether the incoming call includes a priority identification designation that matches a valid priority identification designation stored in the processor;
and if the priority identification designation matches the valid priority designation stored in the processor, then the processor provides the communication device with a priority alert.

15. The apparatus of claim 14 wherein the processor is integrated into one of: the switching system and a voicemail system coupled to the switching system.

16. The apparatus of claim 15 wherein the priority alert is distinguished from a non-priority alert and comprises one of: a predetermined ring tone, a visual display, a predetermined call waiting treatment, and a data message.

17. The apparatus of claim 15 wherein the processor determines whether an incoming call for the communication device is a priority call by determining whether the incoming call has a priority call request and a priority identification designation.

18. The apparatus of claim 15 wherein the processor determines whether an incoming call for the communication device is a priority call by prompting an originator of the call for a priority call request and a priority identification designation.
